(19) United States
(12) Patent Application Publication
(10) Pub. No.: US 2026/0081310 A1
(43) Pub. Date: Mar. 19, 2026

(54) ELECTRODE ASSEMBLY AND SECONDARY BATTERY INCLUDING SAME

(71) Applicant: SAMSUNG SDI CO., LTD., Yongin-si (KR)

(72) Inventors: Hyunsoo KIM, Yongin-si (KR); Donghyuk Ko, Yongin-si (KR); Jeongyeon Lee, Yongin-si (KR); Hyungin Lee, Yongin-si (KR)

(21) Appl. No.: 19/227,640

(22) Filed: Jun. 4, 2025

(30) Foreign Application Priority Data
Sep. 13, 2024 (KR) 10-2024-0126150

(51) Int. Cl. H01M 50/533; H01M 10/04

(52) U.S. Cl. CPC H01M 50/533; H01M 10/0431

(57) ABSTRACT

A secondary battery, including an electrode assembly having a first electrode, a second electrode, and a separator between the first electrode and the second electrode, wound around a winding axis, a case configured to accommodate the electrode assembly, the case electrically connected to the second electrode, and a cap assembly configured to seal an opening of the case, the cap assembly electrically connected to the first electrode, wherein the first electrode includes a first active material coated portion including a substrate in which an active material is coated along a winding direction and a first uncoated portion including a substrate in which an active material is not coated, and the first uncoated portion of the first electrode includes a first region having a thickness less than a thickness of the substrate of the first active material coated portion.

This application claims priority under 35 U.S.C §119 to Korean Patent Application No. 10-2024-0126150, filed in the Korean Intellectual Property Office on September 13, 2024, the entire contents of which are hereby incorporated by reference.

### BACKGROUND

### 1. Field

Embodiments relate to an electrode assembly and a secondary battery including the same.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Embodiments are directed to a secondary battery, including an electrode assembly including a first electrode, a second electrode, and a separator between the first electrode and the second electrode, wound around a winding axis, a case configured to accommodate the electrode assembly, the case electrically connected to the second electrode, and a cap assembly configured to seal an opening of the case, the cap assembly electrically connected to the first electrode, wherein the first electrode includes a first active material coated portion including a substrate in which an active material is coated along a winding direction and a first uncoated portion including a substrate in which an active material is not coated, and the first uncoated portion of the first electrode includes a first region having a thickness less than a thickness of the substrate of the first active material coated portion.

The thickness of the first region of the first uncoated portion may decrease as a distance from the first active material coated portion increases.

The secondary battery may further include a first insulating layer on the first uncoated portion and the first insulating layer may be in a region other than the first region of the first uncoated portion.

The first region of the first uncoated portion may form a step with a remaining region of the first uncoated portion.

The first uncoated portion may include a remaining region having a constant thickness and the first region of the first uncoated portion may extend outside the remaining region of the first uncoated portion.

An upper surface of the first region of the first uncoated portion may have a curved shape.

The secondary battery may further include a first insulating layer on a partial portion of the first region of the first uncoated portion.

The secondary battery may further include a first insulating layer on a partial portion of the first region of the first uncoated portion.

The second electrode may include a second active material coated portion in which an active material may be coated along a winding direction and a second uncoated portion in which an active material may not be coated, and the second uncoated portion of the second electrode may include a region having a thickness less than a thickness of a substrate of the second active material coated portion.

The first uncoated portion may include a metal.

The first uncoated portion may include a base insulating layer and a metal layer on at least one surface of the base insulating layer.

A thickness of the base insulating layer in a region corresponding to the first region of the first uncoated portion may be less than a thickness of the base insulating layer in a region corresponding to a remaining region of the first uncoated portion.

A thickness of the metal layer in a region corresponding to the first region may be less than a thickness of the metal layer in a region corresponding to a remaining region of the first uncoated portion.

The first uncoated portion may include a plurality of substrate tabs, and widths of the substrate tabs in the winding direction may be different from each other.

The first uncoated portion may include a plurality of substrate tabs, and lengths of the substrate tabs protruding from the first active material coated portion may be different from each other.

The first uncoated portion may include a plurality of substrate tabs, and an end portion of each of the substrate tabs may be inclined with respect to the winding direction.

The first uncoated portion may include a plurality of substrate tabs, and an end portion of each of the substrate tabs may have a curved shape.

The first uncoated portion may include a plurality of substrate tabs, and an end portion of each of the substrate tabs may have a polygonal shape or a semicircular shape.

The first uncoated portion may include a plurality of substrate tabs, a length of each of the substrate tabs protruding from the first active material coated portion may increase stepwise along the winding direction, and the substrate tabs may be spaced apart by a predetermined interval.

Embodiments are directed to an electrode assembly including a first electrode, a second electrode, and a separator between the first electrode and the second electrode, wherein the first electrode, the second electrode, and the separator may be wound around a winding axis, at least one of the first electrode and the second electrode may include an active material coated portion including a substrate on which an active material is coated along a winding direction and a first uncoated portion including a substrate on which an active material may not be coated, and the first uncoated portion may include a first region having a thickness less than a thickness of the substrate of the active material coated portion.

### BRIEF DESCRIPTION OF THE DRAWINGS

Features will become apparent to those of skill in the art by describing in detail exemplary embodiments with reference to the attached drawings in which:

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a cross-sectional view showing a secondary battery according to an embodiment of the present disclosure;

FIG. 2 illustrates a perspective view showing an example of a first electrode of an electrode assembly of a secondary battery according to an embodiment of the present disclosure;

FIG. 3 illustrates a cross-sectional view showing an example of the first electrode of FIG. 2 according to an embodiment of the present disclosure;

FIG. 4 illustrates a cross-sectional view showing an example of a first electrode according to an embodiment of the present disclosure;

FIGS. 5 to 8 illustrate cross-sectional views showing various examples of a first electrode according to an embodiment of the present disclosure;

FIGS. 9 and 10 illustrate cross-sectional views showing various examples of a first electrode including a mixture substrate according to an embodiment of the present disclosure; and

FIGS. 11A to 11D illustrate plan views showing various examples of a first electrode according to an embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or "over" the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being "linked," "coupled," or "connected" to another component, the elements may be directly “coupled,” “linked” or "connected" to each other, or another component may be "interposed" between the components".

Throughout the specification, when "A and/or B" is stated, it means A, B or A and B, unless otherwise stated. That is, “and/or” includes any or all combinations of a plurality of items enumerated. When "C to D" is stated, it means C or more and D or less, unless otherwise specified.

In the present disclosure, the sizes and relative sizes of layers and regions shown in the drawings may be exaggerated for clarity of description. That is, the sizes shown in the drawings are only for convenience of understanding. In addition, the same reference numerals denote the same elements throughout the specification.

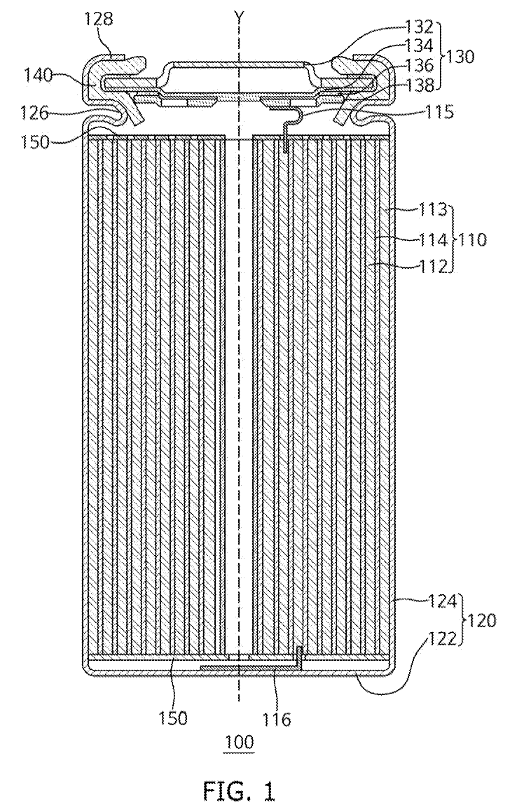

FIG. 1 illustrates a cross-sectional view showing a secondary battery according to an embodiment of the present disclosure.

As shown in FIG. 1, a secondary battery includes an electrode assembly, a case accommodating the electrode assembly and an electrolyte therein, a cap assembly coupled to an opening of the case to seal the case, and an insulating plate positioned between the electrode assembly and the cap assembly inside the case.

The electrode assembly 110 may include a separator 114 and a first electrode 112 and a second electrode 113 positioned with the separator interposed therebetween and may be wound in a jelly roll shape with respect to a winding axis Y.

The first electrode 112 includes a first substrate and a first active material layer on the first substrate. A first lead tab 115 may extend outwardly from a first uncoated portion of the first substrate at where the first active material layer is not located, and the first lead tab 115 may be electrically connected to the cap assembly 130.

The second electrode 113 includes a second substrate and a second active material layer on the second substrate. A second lead tab 116 may extend outwardly from a second uncoated portion of the second substrate at where the second active material layer is not located, and the second lead tab 116 may be electrically connected to the case 120. The first lead tab 115 and the second lead tab 116 may extend in opposite directions.

The first electrode 112 may act as a positive electrode. In such an embodiment, the first substrate may be made of, for example, an aluminum foil, and the first active material layer may include, for example, a transition metal oxide. The second electrode 113 may act as a negative electrode. In such an embodiment, the second substrate may be made of, for example, a copper foil or a nickel foil, and the second active material layer may include graphite, for example.

The separator 114 prevents a short circuit between the first electrode 112 and the second electrode 113 while allowing movement of lithium ions therebetween. The separator 114 may be made of, for example, a polyethylene film, a polypropylene film, a polyethylene-polypropylene film, or the like.

The case 120 accommodates the electrode assembly 110 and, together with the cap assembly 130, forms the external appearance of the secondary battery 100. The case 120 may have a substantially cylindrical body portion 124 and a bottom portion 122 connected to one side (e.g., to one end) of the body portion 124. A beading part 126 (e.g., a bead) deformed inwardly may be formed in the body portion 124, and a crimping part 128 (e.g., a crimp) bent inwardly may be formed at an open end of the body portion 124.

The beading part 126 can reduce or prevent movement of the electrode assembly 110 inside the case 120 and can facilitate seating of the gasket 140 and the cap assembly 130. The crimping part 128 may firmly fix the cap assembly 130 by pressing the edge of the case 120 against the gasket 140. The case 120 may be formed of iron plated with nickel, for example.

The cap assembly 130 may include, e.g., a safety vent 134, a cap-up 132 above the safety vent 134, and a cap-down 138 below the safety vent 134. The cap assembly 130 may further include, e.g., an insulating member 136 between the safety vent 134 and the cap-down 138 to insulate therebetween so that a part other than the central portion of the safety vent 134 does not come into contact with the cap-down 138, and a gasket 140 that may insulate between the cap assembly 130 and the case 120. The safety vent 134 may be in contact with the cap-down 138 at the central portion of the case 120, and the portion supported by the insulating member 136 may be spaced apart from the cap-down 138. The safety vent 134 may have a notch formed to rupture and release gas in a case where the internal pressure rises above a certain level.

The insulating plate 150 may be positioned to be in contact with the electrode assembly 110 below the beading part 126. The insulating plate 150 may have a tab opening through which the first lead tab 115 is drawn out. The cap assembly 130, which is electrically connected to the first electrode 112 by the first lead tab 115, may face the electrode assembly 110 with an insulating plate 150 interposed therebetween and may maintain a state of being insulated (e.g., electrically insulated) from the electrode assembly 110 by the insulating plate 150.

The case where the secondary battery according to the present disclosure is cylindrical has been described above, but this is only an example, and the embodiments according to the present disclosure may be applied to other types of secondary batteries, e.g., pouch-type and prismatic-type.

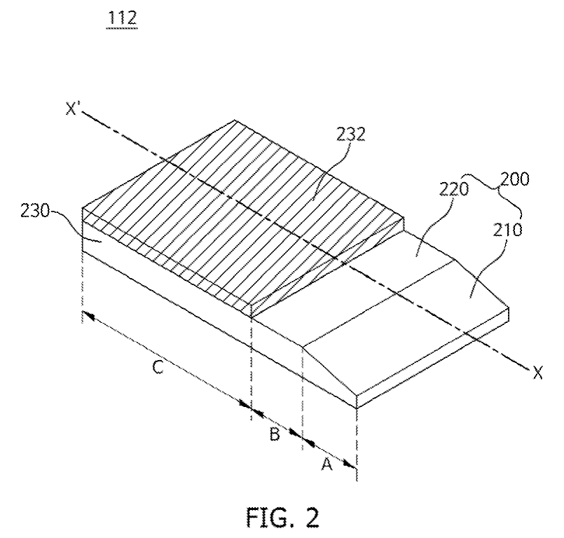

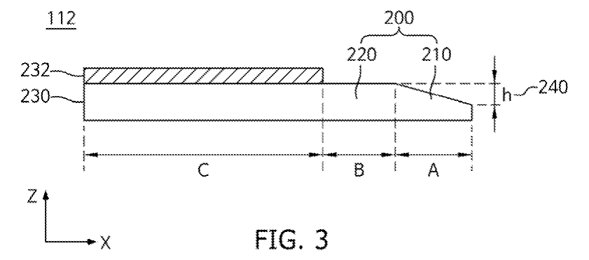

FIG. 2 illustrates a perspective view showing an example of a first electrode of an electrode assembly of a secondary battery according to an embodiment of the present disclosure. FIG. 3 illustrates a cross-sectional view showing an example of the first electrode of FIG. 2 according to an embodiment of the present disclosure.

Referring to FIGS. 2 and 3, in an embodiment, a first electrode 112 of an electrode assembly 110 may include, e.g., an uncoated portion 200 including a substrate on which an active material 232 is not coated and an active material coated portion 230 including a substrate in which the active material 232 is coated on one surface or opposite surfaces of along the winding direction. The active material coated portion 230 or the uncoated portion 200 may, e.g., include or be composed of a metal substrate.

In an embodiment, the uncoated portion 200 may include, e.g., a first region 210 having a substrate thickness less than that of the active material coated portion 230 in which the active material 232 is coated. In some embodiments, the uncoated portion 200 may include, e.g., a second region 220 having a constant thickness, and the first region 210 may extend outside the second region 220. In an implementation, the thickness of the substrate of the second region 220 may be equal to the thickness of the substrate of the active material coated portion 230. The thickness direction may be parallel to the Z axis and perpendicular to the X axis noted in FIG. 3.

In an embodiment, the first region 210 may include, e.g., a substrate tab portion. All or part of the first region 210 may form the substrate tab portion. The substrate tab portion may be electrically connected to an electrode terminal or a current collector in physical contact with the electrode terminal or the current collector. In another example, parts of the first region 210 and the second region 220 may constitute the substrate tab portion together. That is, the length and shape of the substrate tab may vary depending on the type and design of the secondary battery. In an embodiment, in order for the substrate tab portion to function as a current collector and to function as a current collector by being directly electrically connected to the electrode terminal, the maximum range (h) 240 of the thickness reduction of the substrate tab portion may be 90% of the substrate thickness before reduction. That is, the thinnest region of the substrate tab portion may have a thickness greater than 10% of the thickness of a region of constant thickness in the substrate tab portion.

In an embodiment, the thickness of the substrate of the uncoated portion 200 may be reduced (e.g., etched) as the distance from the active material coated portion 230 increases, thereby forming the first region 210 that is thinner than the substrate of the active material coated portion 230. For example, the first region 210 may get thinner as the distance from the active material coated portion 230 increases. The first region 210 may be formed, e.g., using ball milling or scraping, which may include mechanical milling, laser cutting or laser ablation laser, which may include laser processing, or the like. In some embodiments, e.g., wet etching or dry etching, which are chemical etching methods, electropolishing, or the like may be included as other methods of forming the first region 210.

FIGS. 2 and 3 show the first electrode 112, however the embodiments may be similarly applied to all materials that can be utilized as the current collector, such as in the positive electrode, the negative electrode, or the mixture substrate. In an implementation, the second electrode 113 may include an active material coated portion in which an active material is coated along the winding direction and an uncoated portion in which an active material is not coated, and the uncoated portion of the second electrode 113 may include a region having a thickness less than the substrate of the active material coated portion.

With this electrode structure, the cutting shape and the thickness and height of the substrate tab may be adjusted to minimize the amount of overlap between the substrates in a case of compacting the substrate tabs, thereby ensuring the maximum free space within the battery. In some embodiments, the width of the electrode plate may be increased by the amount of additional free space that can be ensured as described above.

With this electrode structure, even in a case where the basic structure of the secondary battery (e.g., the space formed by the case or the cap assembly) is the same, an additional effective space may be ensured, thereby increasing the capacity of the secondary battery substantially.

With this electrode structure, the thickness of the substrate tab portion may be reduced to the extent that all of the substrate tabs overlap in a case of being compacted. Accordingly, there may not be a concern about increased resistance due to a decrease in the current path, and the resistance may be reduced and the output may be increased by reducing the thickness of the substrate, thereby increasing the efficiency of the secondary battery and contributing to optimizing battery performance.

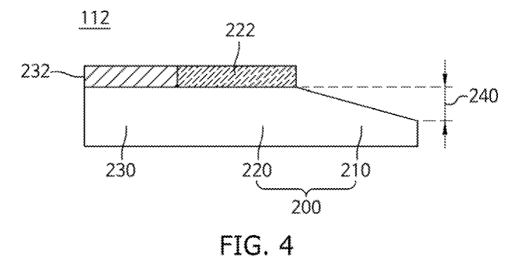

FIG. 4 illustrates a cross-sectional view showing an example of a first electrode according to an embodiment of the present disclosure. In FIG. 4, descriptions redundant with those provided above with reference to FIGS. 2 and 3 may be omitted.

In an embodiment, an uncoated portion 200 of a first electrode 112 may include, e.g., a second region 220 having a constant thickness, a first region 210 having a thickness that gradually decreases as a distance from an active material coated portion 230 increases and thus has a thickness that is less than a thickness of a substrate of an active material coated portion 230, and an insulating layer 222 on a region other than the first region 210 of the uncoated portion, e.g., a second region 220. The active material coated portion 230 may include an active material 232 coated on the substrate.

In an embodiment, the insulating layer 222 may be implemented by coating a thin insulating film on the uncoated portion or by configuring the substrate itself to include an insulating material.

The insulating layer 222 as described above may prevent electrical short circuit between the first electrode 112 and the second electrode 113 and may help increase the stability of the battery. In an implementation, the insulating layer 222 may prevent the first electrode 112 and the second electrode 113 from being electrically connected to each other in a case where the first electrode 112, the separator, and the second electrode 113 constituting the electrode assembly are stacked and wound.

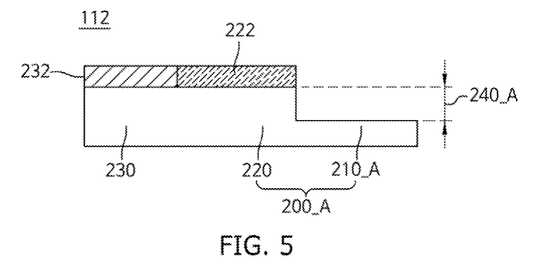

FIGS. 5 to 8 illustrate cross-sectional views showing various examples of a first electrode according to an embodiment of the present disclosure. In FIGS. 5 to 8, descriptions redundant with those provided above with reference to FIGS. 2 to 4 may be omitted.

Referring to FIG. 5, the first electrode 112 may include, e.g., an uncoated portion 200_A in which the active material 232 is not coated and an active material coated portion 230 in which the active material 232 is coated. In some embodiments, the uncoated portion 200_A may include, e.g., a second region 220 on which the insulating layer 222 may be located and a first region 210_A on which the insulating layer 222 may not be located and which may function as a current collector.

The first region 210_A may correspond to the substrate tab portion and may have a structure that may be thinner than the substrate of the active material coated portion 230 and may form a step 240_A with the remaining region of the uncoated portion 200_A, e.g., with the second region 220.

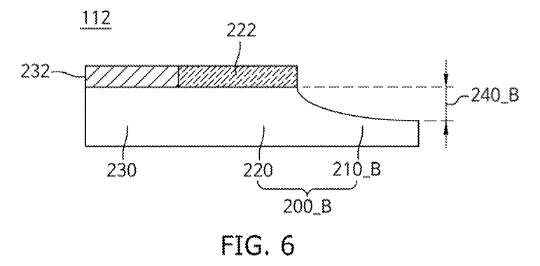

Referring to FIG. 6, the first electrode 112 may include an uncoated portion 200_B in which the active material 232 is not coated and an active material coated portion 230 in which the active material 232 is coated. In some embodiments, the uncoated portion 200_B may include a second region 220 on which the insulating layer 222 may be located and a first region 210_B on which the insulating layer 222 may not be located and which may function as a current collector. For example, the first region 210_B may function as a current collector.

The first region 210_B may correspond to the substrate tab portion, and the upper surface of the first region 210_B may be formed by, e.g., etching to have a curved shape. Accordingly, the substrate tab portion may correspond to the first region 210_B that is thinner than the substrate of the active material coated portion 230.

To express, e.g., describe, FIG. 6 differently, the uncoated portion 200_B included in the first electrode 112 may include a first region 210_B having a thinner thickness than the substrate of the active material coated portion 230 and a second region 220 having a constant thickness, and the first region 210_B may have a structure extending outside the second region.

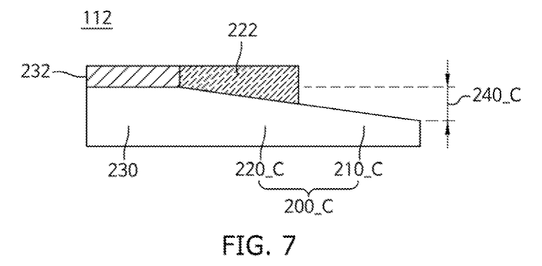

Referring to FIG. 7, the first electrode 112 may include, e.g., an uncoated portion 200_C in which the active material 232 is not coated and an active material coated portion 230 in which the active material 232 is coated. In some embodiments, the uncoated portion 200_C may include, e.g., a second region 220_C on which the insulating layer 222 may be located and a first region 210_C on which both the second region 220_C and the insulating layer 222 are not located and which may function as a current collector. For example, the first region 210_C may function as a current collector. In other words, the insulating layer 222 may be on (e.g., coated on) a partial portion of the first region of the uncoated portion 200_C. In some embodiments, the entire uncoated portion 200_C including the first region 210_C and the second region 220_C may be etched, e.g., so that the thickness thereof gradually decreases as the distance from the active material coated portion 230 increases. For example, the entire uncoated portion may correspond to a portion that is thinner than the substrate of the active material coated portion 230. In an implementation, the uncoated portion 200_C, e.g., the first region 210_C and the second region 220_C, may each have a certain thickness difference between the substrate of the active material coated portion 230 and the portion having the smallest thickness of the substrate, because the thickness of the substrate decreases as the distance from the active material coated portion 230 increases.

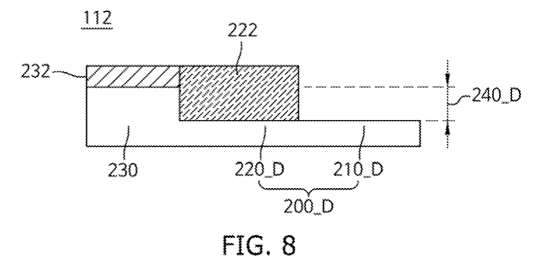

Referring to FIG. 8, the first electrode 112 may include an uncoated portion 200_D which the active material 232 is not coated and an active material coated portion 230 in which the active material 232 is coated. In some embodiments, the uncoated portion 200_D may include, e.g., a second region 220_D on which the insulating layer 222 is coated and a first region 210_D on which the insulating layer 222 is not coated and which may function as a current collector. For example, the first region 210_D may function as a current collector.

The entire uncoated portion 200_D including the first region 210_D and the second region 220_D may form a step 240_D with the substrate of the active material coated portion 230. For example, the remaining portion of the substrate of the first electrode except for the active material coated portion 230 may be etched to form a step.

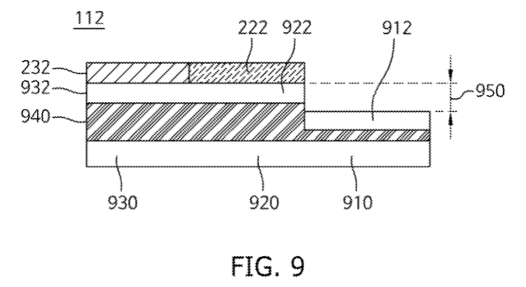

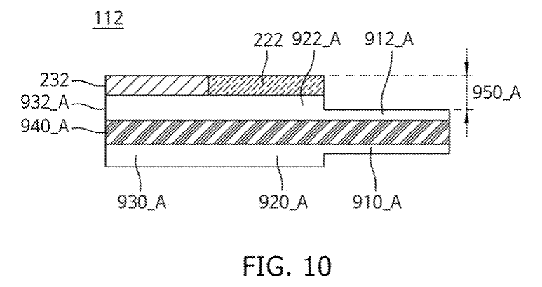

FIGS. 9 and 10 illustrate cross-sectional views showing various examples of a first electrode including a mixture substrate, e.g., a mixed substrate, according to an embodiment of the present disclosure. In FIGS. 9 and 10, descriptions redundant with those provided above with reference to FIGS. 2 to 8 may be omitted.

Referring to FIG. 9, a first electrode 112 may be formed using a mixture substrate. In an implementation, the first electrode 112 may include, e.g., active material coated portion 930 and 932 in which an active material 232 is coated and an uncoated portion in which an active material is not coated. The uncoated portion may include, e.g., a portion of a base insulating layer 940 and metal layers 910, 920, 912, and 922 which may be on at least one surface of a portion of the base insulating layer 940.

In an embodiment, the metal layers 910 and 920 included in a first region in the uncoated portion may function as a current collector in which an insulating layer 222 and the active material 232 are not on one surface. In some embodiments, in the uncoated portion, the insulating layer 222 may be on one surface of a part of the metal layer 922 of the metal layers 920 and 922 included in the second region.

In an embodiment, in the uncoated portion, the base insulating layer 940 may have a step. For example, the base insulating layer 940 may include a first region and a second region having a thickness greater than the first region, and a step may be formed between the two regions. The second region of the base insulating layer 940 may be a region adjacent to the active material coated portion and may have substantially the same thickness as the base insulating layer of the active material coated portion, and the first region may be outside the second region.

That is, according to an embodiment, the cutting shape or the thickness and height of the substrate tab, etc. may be controlled by forming the thickness of the base insulating layer of the mixture substrate differently for each region.

Referring to FIG. 10, the first electrode 112 may include, e.g., active material coated portions 930_A and 932_A in which the active material 232 may be coated and an uncoated portion made of a substrate in which the active material may not be coated. The uncoated portion may include, e.g., a portion of the base insulating layer 940_A and metal layers 910_A, 920_A, 912_A, and 922_A which may be on at least one surface of a portion of the base insulating layer 940_A.

In an embodiment, the metal layers 910_A and 920_A included in the first region in the uncoated portion may function as a current collector in which an insulating layer 222 is not on one surface. In some embodiments, in the uncoated portion, the insulating layer 222 may be on one surface of at least a part of the metal layer 922_A of the metal layers 920_A and 922_A included in the second region.

In an embodiment, the base insulating layer 940_A included in the uncoated portion may have a constant thickness. In some embodiments, in the uncoated portion, the metal layer may have a step. In an implementation, the metal layers 920_A and 922_A included in the second region of the uncoated portion may have a thickness greater than a thickness of the metal layers 910_A and 912_A included in the first region of the uncoated portion. This may form a step between the two regions of metal layers.

In an embodiment, the metal layers 920_A and 922_A included in the second region of the uncoated portion may be portions adjacent to the active material coated portion and may have substantially the same thickness as the thickness of the metal layer of the active material coated portion, and the first region may be outside the second region.

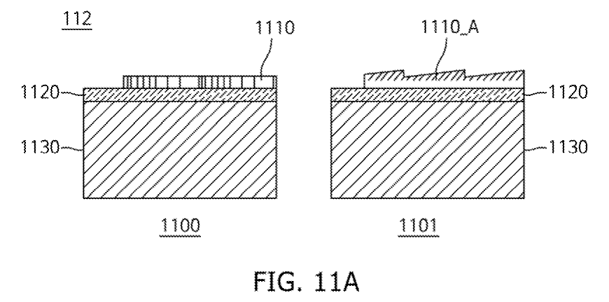

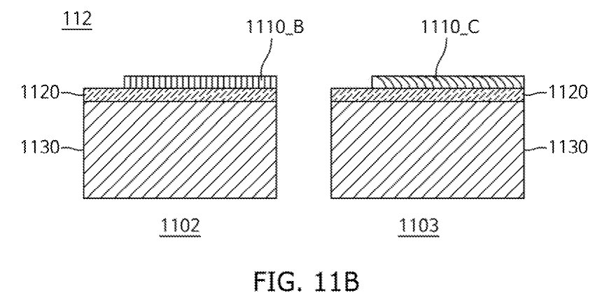

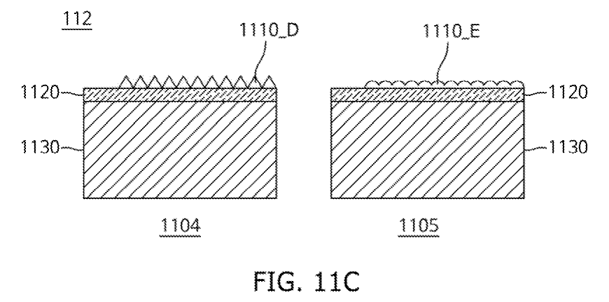

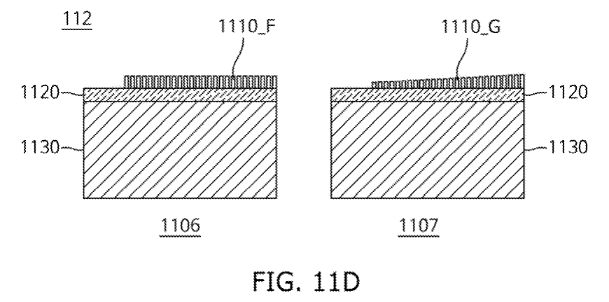

FIGS. 11A to 11D illustrate plan views showing various examples of the first electrode 112 according to an embodiment of the present disclosure. While FIGS. 2 to 10 relate to the thickness control of the first region included in the first electrode 112, FIGS. 11a to 11d relate to embodiments of the width, length, and pattern control of the first region. Additionally, or alternatively, to the embodiments relating to thickness control of the first region described above with reference to FIGS. 2 to 10, the width, length, pattern, or the like of the first region described with reference to FIGS. 11A to 11D may be controlled. In FIGS. 11A to 11D, descriptions redundant with those provided above with reference to FIGS. 2 to 10 may be omitted.

Referring to FIGS. 11A to 11D, first electrodes 1100 to 1107 may respectively include, e.g., an active material coated portion 1130 in which an active material may be coated and an uncoated portion in which an active material may not be coated. The uncoated portion may respectively include a second region 1120 in which an insulating layer may be located and first regions 1110 and 1110_A to 1110_G in which an insulating layer may not be located and which may function as a current collector.

Referring to FIG. 11A, in an embodiment, the uncoated portion or the first region 1110 of the first electrode 1100 may include, e.g., a plurality of substrate tabs formed by cutting an end portion thereof. The width in the winding direction (e.g., from the core side of the electrode assembly to the outer circumference side of the electrode assembly) may be different in the substrate tabs. In an implementation, the substrate tabs may be formed so that the width of each substrate tab varies periodically. For example, as in the illustrated example of the first electrode 1100, one cycle (e.g., one period) may be made up of a certain number of substrate tabs (e.g., 9), the substrate tabs may be formed so that the widths thereof vary according to a certain rule within one cycle, and this may be repeated for each cycle.

In an embodiment, the uncoated portion or the first region 1110_A of the first electrode 1101 may include a plurality of substrate tabs formed by cutting an end portion thereof. The lengths of the substrate tabs protruding from the active material coated portion 1130 may be different from each other. In an implementation, the substrate tabs may be formed so that the length of each substrate tab varies periodically. For example, as in the illustrated example of the first electrode 1101, one cycle (e.g., one period) may be made up of a certain number of substrate tabs, the substrate tabs may be formed so that the lengths thereof vary according to a certain rule within one cycle, and this may be repeated for each cycle.

In some embodiments, the first electrode 1101 or the first region 1110_A may include a plurality of substrate tabs formed by cutting, e.g., an end portion thereof. Each of the substrate tabs may have a cut surface having an oblique direction and be inclined with respect to the winding direction.

Referring to FIG. 11B, in an embodiment, the uncoated portion or the first region 1110_B of the first electrode 1102 may include a plurality of substrate tabs formed by cutting an end portion thereof, and a cut cross-section of each of the substrate tabs may be angulated, e.g., be angular. In comparison, the uncoated portion or the first region 1110_C of the first electrode 1103 may include a plurality of substrate tabs formed by cutting an end portion thereof, and the cut upper surface of each of the substrate tabs may have a curved surface.

Referring to FIG. 11C, in an embodiment, the uncoated portion or the first region 1110_D of the first electrode 1104 may include a plurality of substrate tabs formed by cutting an end portion thereof, and each end portion of the substrate tabs may have, e.g., a polygonal shape, including a triangular shape. In some embodiments, the uncoated portion or the first region 1110_E of the first electrode 1105 may include a plurality of substrate tabs formed by cutting an end portion thereof, and each end portion of the substrate tabs may have a protrusion having a semicircular shape. In an implementation, the protruding length of each of the substrate tabs in the uncoated portion or the first regions of the first electrodes 1104 and 1105 may be repeatedly increased or decreased in the winding direction with a certain cycle.

Referring to FIG. 11D, in an embodiment, the uncoated portion or the first region 1110_F of the first electrode 1106 may include a plurality of substrate tabs formed by cutting an end portion thereof, and the length of each of the substrate tabs protruding from the active material coated portion 1130 may be constant along the winding direction. In some embodiments, each of the substrate tabs may have a constant or different width in the winding direction. In some embodiments, the substrate tabs may be spaced apart from each other by a certain distance.

In an embodiment, the uncoated portion or the first region 1110_G of the first electrode 1107 may include a plurality of substrate tabs formed by cutting an end portion thereof, and the length of each of the substrate tabs protruding from the active material coated portion 1130 may be increased stepwise along the winding direction. In some embodiments, each of the substrate tabs may have a constant or different width in the winding direction. In some embodiments, the substrate tabs may be spaced apart from each other by a certain distance.

By way of summation and review, secondary batteries may be manufactured by inserting an electrode assembly into a case and then sealing a cap assembly. The electrode assembly may include a wound electrode assembly formed by winding a positive electrode, a negative electrode, and a separator. For the electrode assembly, a plurality of substrate tabs may be formed by performing notching on an uncoated portion where an active material is not coated, and the notched substrate tabs may be connected to a current collector plate. In this process, the notched substrate tabs may be irregularly bent and the amount of overlap may increase, which may result in damage to the substrate and may cause a problem in which the overlap thickness of the substrate tabs increases excessively.

These and other aspects and features of the present disclosure will be described in or will be apparent from the above description of embodiments of the present disclosure.

However, aspects and features of the present disclosure are not limited to those described above, and other aspects and features not mentioned will be clearly understood by a person skilled in the art from the detailed description, described above.

Aspects of embodiments of the present disclosure may provide an electrode assembly and a secondary battery.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated.Accordingly, it will be understood by those of skill in the art that various changes in form and details may be made without departing from the spirit and scope of the present invention as set forth in the following claims.

WHAT IS CLAIMED IS:

1. A secondary battery, comprising:
an electrode assembly including a first electrode, a second electrode, and a separator between the first electrode and the second electrode, wound around a winding axis;
a case configured to accommodate the electrode assembly, the case electrically connected to the second electrode; and
a cap assembly configured to seal an opening of the case, the cap assembly electrically connected to the first electrode,
wherein:
the first electrode includes a first active material coated portion including a substrate on which an active material is coated along a winding direction and a first uncoated portion including a substrate on which an active material is not coated, and
the first uncoated portion of the first electrode includes a first region having a thickness less than a thickness of the substrate of the first active material coated portion.

2. The secondary battery as claimed in claim 1, wherein the thickness of the first region of the first uncoated portion decreases as a distance from the first active material coated portion increases.

3. The secondary battery as claimed in claim 1, further comprising a first insulating layer on the first uncoated portion,
wherein the first insulating layer is in a region other than the first region of the first uncoated portion.

4. The secondary battery as claimed in claim 1, wherein the first region of the first uncoated portion forms a step with a remaining region of the first uncoated portion.

5. The secondary battery as claimed in claim 1, wherein the first uncoated portion includes a second region having a constant thickness and the first region of the first uncoated portion extends outside the second region of the first uncoated portion.

6. The secondary battery as claimed in claim 2, wherein an upper surface of the first region of the first uncoated portion has a curved shape.

7. The secondary battery as claimed in claim 2, further comprising a first insulating layer on a partial portion of the first region of the first uncoated portion.

8. The secondary battery as claimed in claim 4, further comprising a first insulating layer on a partial portion of the first region of the first uncoated portion.

9. The secondary battery as claimed in claim 1, wherein:
the second electrode includes a second active material coated portion in which an active material is coated along a winding direction and a second uncoated portion in which an active material is not coated, and
the second uncoated portion of the second electrode includes a region having a thickness less than a thickness of a substrate of the second active material coated portion.

10. The secondary battery as claimed in claim 1, wherein the first uncoated portion includes a metal.

11. The secondary battery as claimed in claim 1, wherein the first uncoated portion includes:
a base insulating layer; and
a metal layer on at least one surface of the base insulating layer.

12. The secondary battery as claimed in claim 11, wherein a thickness of the base insulating layer in a region corresponding to the first region of the first uncoated portion is less than a thickness of the base insulating layer in a region corresponding to a remaining region of the first uncoated portion.

13. The secondary battery as claimed in claim 11, wherein a thickness of the metal layer in a region corresponding to the first region is less than a thickness of the metal layer in a region corresponding to a remaining region of the first uncoated portion.

14. The secondary battery as claimed in claim 1, wherein:
the first uncoated portion includes a plurality of substrate tabs, and
widths of the substrate tabs in the winding direction are different from each other.

15. The secondary battery as claimed in claim 1, wherein:
the first uncoated portion includes a plurality of substrate tabs, and
lengths of the substrate tabs protruding from the first active material coated portion are different from each other.

16. The secondary battery as claimed in claim 1, wherein:
the first uncoated portion includes a plurality of substrate tabs, and
an end portion of each of the substrate tabs is inclined with respect to the winding direction.

17. The secondary battery as claimed in claim 1, wherein:
the first uncoated portion includes a plurality of substrate tabs, and
an end portion of each of the substrate tabs has a curved surface.

18. The secondary battery as claimed in claim 1, wherein:
the first uncoated portion includes a plurality of substrate tabs, and
an end portion of each of the substrate tabs has a polygonal shape or a semicircular shape.

19. The secondary battery as claimed in claim 1, wherein:
the first uncoated portion includes a plurality of substrate tabs,
a length of each of the substrate tabs protruding from the first active material coated portion increases stepwise along the winding direction, and
the substrate tabs are spaced apart by a predetermined interval.

20. An electrode assembly, comprising:
a first electrode;
a second electrode; and
a separator between the first electrode and the second electrode,
wherein:
the first electrode, the second electrode, and the separator are wound around a winding axis,
at least one of the first electrode and the second electrode includes an active material coated portion including a substrate on which an active material is coated along a winding direction and a first uncoated portion including a substrate on which an active material is not coated, and
the first uncoated portion includes a first region having a thickness less than a thickness of the substrate of the active material coated portion.
